(19) United States
(12) Patent Application Publication
(10) Pub. No.: US 2010/0272553 A1
(43) Pub. Date: Oct. 28, 2010

(54) Method And Apparatus For Handling Shingles

(76) Inventor: David P. Aschenbeck, Newark, OH (US)

Correspondence Address: MacMillan, Sobanski & Todd, LLC, One Maritime Plaza, Fifth Floor, 720 Water Street, Toledo, OH, 43604, US

(21) Appl. No.: 12/428,079

(22) Filed: Apr. 22, 2009

(51) Int. Cl. B65G 57/16; B65G 57/00; B65H 35/00

(52) U.S. Cl. 414/788.3; 414/802; 414/749.1

(57) ABSTRACT

A method of stacking shingles includes manufacturing a plurality of shingles having a granule covered surface and a bottom surface opposite the granule covered surface. Every other shingle is separated into first and second paths. The shingles in the second path are inverted 180 degrees. A shingle from the first path is positioned onto a shingle from the second path, such that the bottom surfaces of each shingle are engaged, thereby defining a stacked pair of shingles.

### BACKGROUND

This invention relates in general to a method of manufacturing roofing shingles, and in particular to an improved method of stacking shingles.

Known methods for stacking shingles include U.S. Pat. No. 4,124,128 which discloses a catcher 30 having a pair of starwheels 32 and 33 which selectively flip shingles for subsequent stacking at a stacker and squarer 100.

Another known method for stacking shingles is disclosed in U.S. Pat. No. 4,384,813. U.S. Pat. No. 4,384,813 discloses a shingle stacker in which a star wheel catcher 20, a stack collection hopper 30, and a flipper arm 40 cooperate to catch, flip, and stack shingles.

Known methods of catching and/or stacking shingles often include accelerating the shingles to increase the space between sequential shingles. Such shingle acceleration is also disclosed in U.S. Pat. No. 4,384,813.

It is desirable however, to provide an improved method of stacking shingles.

### SUMMARY

The present application describes various embodiments of a method and apparatus for stacking shingles. One embodiment of the method of stacking shingles includes manufacturing a plurality of shingles having a granule covered surface and a bottom surface opposite the granule covered surface. Every other shingle is separated into first and second paths. The shingles in the second path are inverted 180 degrees. A shingle from the first path is positioned onto a shingle from the second path, such that the bottom surfaces of each shingle are engaged, thereby defining a stacked pair of shingles.

The present application also describes various embodiments of a shingle stacking apparatus including a first assembly for moving a stream of shingles. A diverter assembly engages and separates every other shingle in the stream of shingles into a first stream on a first conveyor and a second stream on a second conveyor. The second conveyor inverts 180 degrees from a first end to a second end thereof and the shingles on the second conveyor are also inverted 180 degrees. An inverted shingle from the second conveyor is first deposited on a shingle receiving portion, and a shingle from the first conveyor is then deposited on the inverted shingle, such that the bottom surfaces of the shingles from each of the first and second conveyors are engaged, thereby defining a stacked pair of shingles.

In another embodiment, the shingle stacking apparatus includes a diverter assembly. The diverter assembly engages and separates every other shingle in a stream of shingles into a first stream on a first conveyor and a second stream on a second conveyor. The second conveyor inverts 180 degrees from a first end to a second end thereof and the shingles on the second conveyor are also inverted 180 degrees. A shingle receiving portion is provided, wherein the first and second conveyors intersect such that an inverted shingle from the second conveyor is first deposited upon the shingle receiving portion, and a shingle from the first conveyor is then deposited on the inverted shingle from the second conveyor, such that the bottom surfaces of the shingles from each of the first and second conveyors are engaged, thereby defining a stacked pair of shingles.

Other advantages of the method of stacking shingles will become apparent to those skilled in the art from the following detailed description, when read in light of the accompanying drawings.

### BRIEF DESCRIPTION OF THE DRAWINGS

FIG. 1 is a schematic illustration of a known process for making shingles.

FIG. 2A is an exploded schematic perspective view of a known laminated shingle.

FIG. 2B is a schematic plan view of the known laminated shingle illustrated in FIG. 2A.

FIG. 3 is a schematic elevational view of one embodiment of an apparatus for twisting and stacking shingles.

FIG. 4 is an enlarged schematic elevational view of a portion of the apparatus illustrated in FIG. 3, showing the diverter assembly in a first position.

FIG. 4A is an enlarged schematic elevational view of the portion of the apparatus illustrated in FIG. 4, showing the diverter assembly in a second position.

FIG. 4B is an enlarged schematic elevational view of the portion of the cams illustrated in FIG. 4.

FIG. 4C is an enlarged schematic elevational view of the portion of the cams illustrated in FIG. 4, showing shingles between the cams.

FIG. 5 is a schematic side view of one embodiment of the upper cam.

FIG. 6 is a schematic side view of the diverter illustrated in FIGS. 3, 4, and 4A.

FIG. 7 is a schematic plan view of the diverter illustrated in FIGS. 3, 4, 4A, and 6.

FIG. 8 is schematic elevational view of one embodiment of a stacked pair of shingles.

### DETAILED DESCRIPTION OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about,” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

As used in the description of the invention and the appended claims, the phrase “inverting 180 degrees” is defined as turning over, rotating, or flipping a shingle along its longest axis, such that the granule covered surface of the shingle is oriented 180 degrees opposite its starting position, and the headlap portion is oriented 180 degrees opposite its starting position.

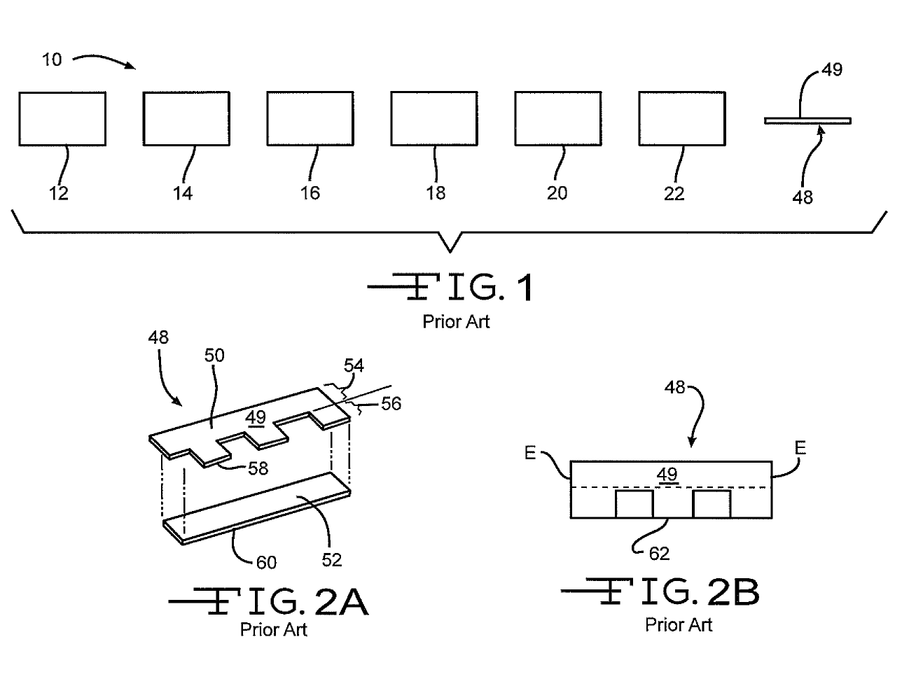

Referring now to the drawings, there is shown in FIG. 1 a schematic illustration of a known manufacturing process 10 for manufacturing an asphalt-based roofing material.

In a first step 12 of the manufacturing process, a continuous sheet of substrate or shingle mat is typically paid out from a roll. The substrate can be any type known for use in reinforcing asphalt-based roofing materials, such as a nonwoven web of glass fibers. In a second step 14, a coating of asphalt is then applied to the sheet. The asphalt coating can be applied in any suitable manner sufficient to completely cover the sheet with a tacky coating of hot, melted asphalt. In a third step 16, granules are applied to the upper surface of the asphalt-coated sheet, thereby defining a granule covered sheet. Typically the granule covered sheet travels at a line speed greater than about 400 feet per minute, and may travel at a faster line speed, such as a line speed within the range of from about 600 feet per minute to about 800 feet per minute. Even faster line speed are possible.

In a fourth step 18, the granule covered sheet may be cut into continuous underlay sheets and continuous overlay sheets. In a fifth step 20, each continuous underlay sheet is directed to be aligned beneath a continuous overlay sheet, and the two sheets are laminated together to form a continuous laminated sheet. In a sixth step 22, the continuous underlay sheet is passed into contact with a cutter, including but not limited to a rotary shingle cutter that cuts the laminated sheet into a running series of laminated individual laminated shingles 48 ready of stacking and packaging.

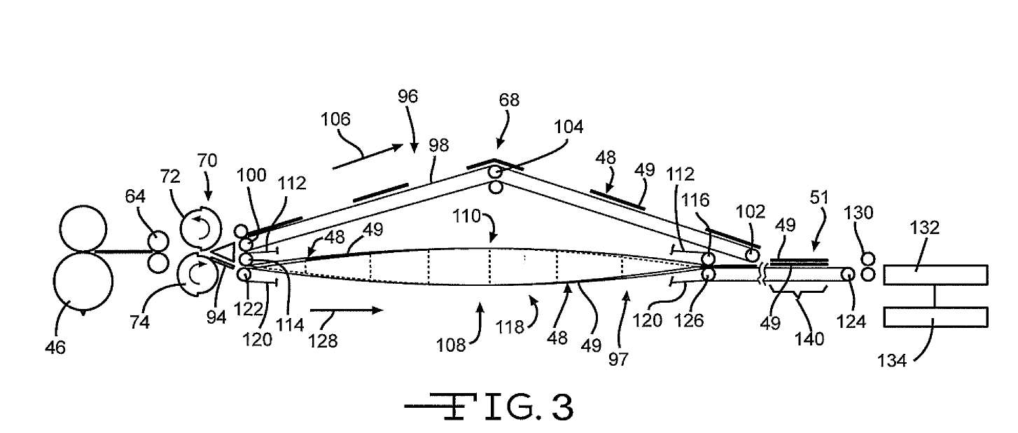

As shown in FIGS. 2A and 2B, the shingle 48 formed by the process illustrated in FIG. 1 includes an overlay sheet 50 and an underlay sheet 52, and defines a granule covered surface 49. The overlay sheet 50 includes an upper or headlap portion 54, a lower or butt portion 56, and end cuts or end surfaces E. A rear surface of the overlay sheet 50 and a front surface of the underlay sheet 52 are fixedly attached to each other to form the laminated shingle 48. Such attachment can be accomplished by using adhesive materials applied to the rear surface of the overlay sheet 50 and the front surface of the underlay sheet 52. In the illustrated embodiment, a butt edge 58 of the butt portion 56 of the overlay sheet 50 and a lower edge 60 of the underlay sheet 52 are vertically aligned to define a lower edge 62 of the shingle 48. If desired, a bead of adhesive (not shown) can be applied to a bottom surface of the underlay sheet 52.

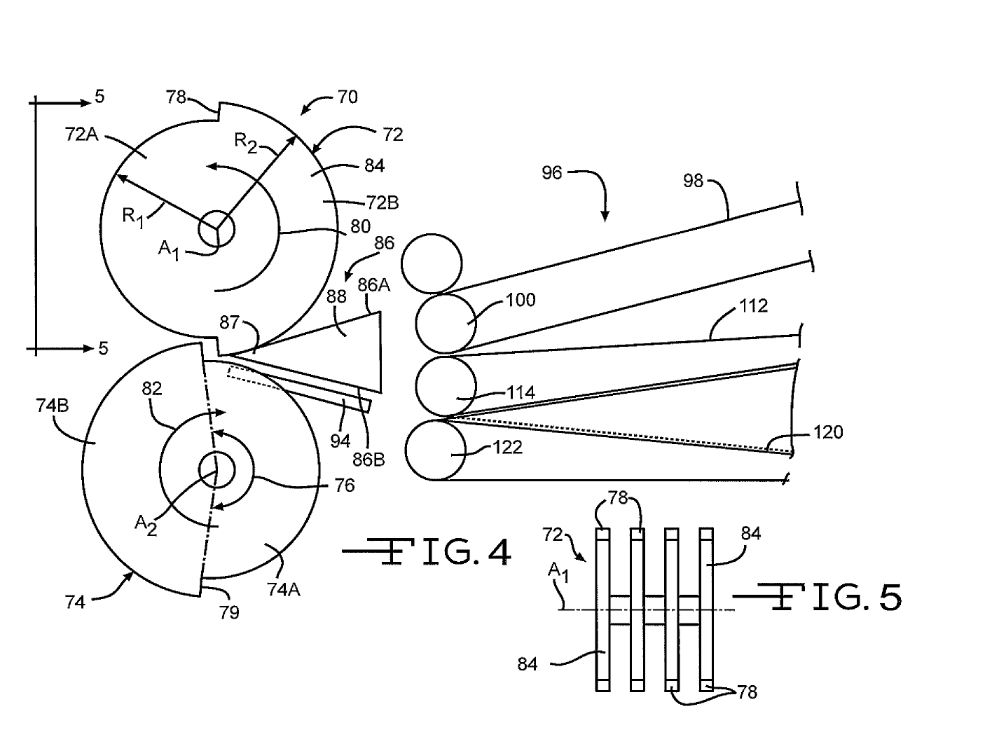

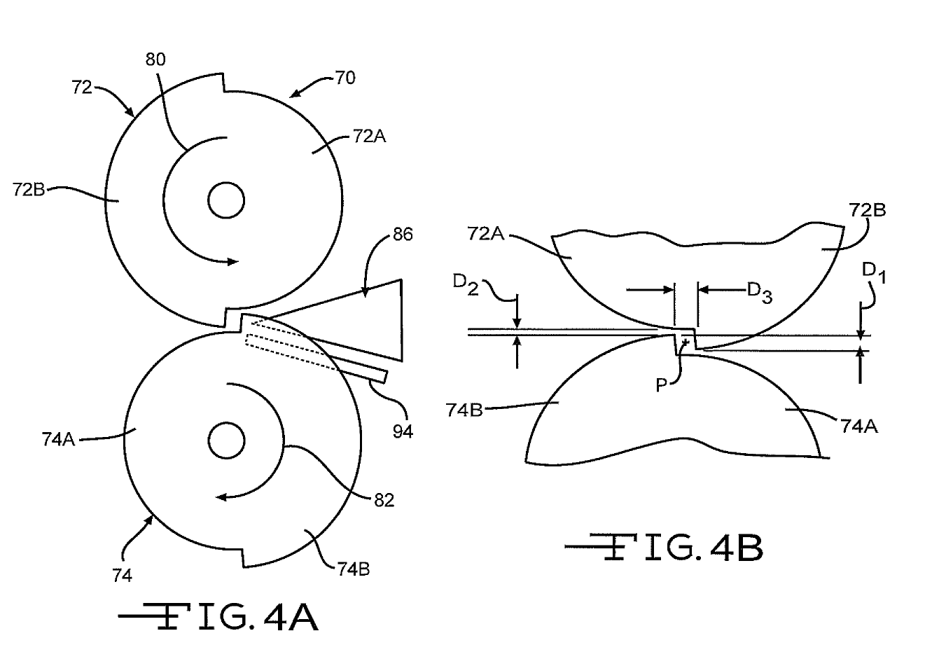

Referring again to the drawings, there is shown in FIGS. 3 through 7, an apparatus 68 for twisting and stacking shingles, such as the laminated shingles 48 according to the invention. The illustrated apparatus 68 includes a diverter assembly 70. The diverter assembly 70 includes a first cam 72 (upper cam when viewing FIG. 4), a second cam 74 (lower cam when viewing FIG. 4), a diverter 86, and a diverter guide member 94.

The first cam 72 has a first portion 72A having a substantially circular circumferential edge and a first radius R₁. A second portion 72B has a substantially circular circumferential edge and a second radius R₂. In the illustrated embodiment the first radius R₁ is about 11 inches and the second radius R₂ is about 13 inches. Alternatively, the first radius R₁ can be any desired length relative to the second radius R₂. For example, the dimensions of the cams 72 and 74 may be determined according to the formula:

(R₁+R₂)/2=2×the length of the shingle.

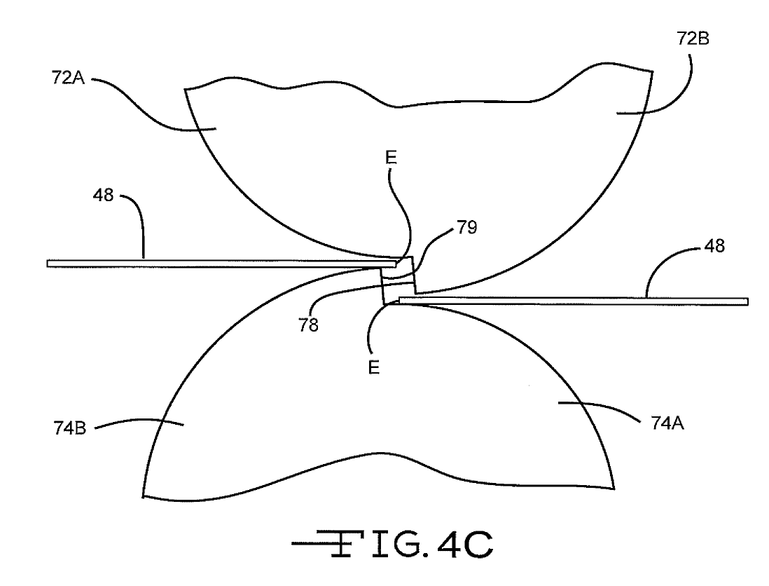

As best shown in FIG. 5, the exemplary embodiment of the first cam 72 is formed from a plurality of substantially parallel and spaced apart cam plates 84 mounted about a first axis of rotation A₁. Four cam plates 84 are illustrated, however any desired number of cam plates 84 may be provided. The plates 84 may be formed from any suitable material. Examples of suitable materials include steel, engineered plastics, and aluminum. Any suitable wear resistant material suitable for use in a roofing material manufacturing plant, such as steel with a high-wear resistant circumferential surface, can be used. Any other suitable metal and non-metal may also be used. The selection of material, and number and dimensions of the plates 84 may be determined by the dimensions of the shingle used in the particular application.

The illustrated cam plates 84 are about ½ inch thick. It will be understood that the cam plates 84 may be any desired thickness, such as within the range of from about ⅛ inch to about 3 inches thick. It will be understood that there will be sufficient space between each plate 84, such that the plates 88 of the diverter 86 may be disposed between adjacent cam plates 84 without engaging the cam plates 88. Alternatively, the first cam 72 may be formed having a continuous outer circumferential surface.

The second cam 74 is substantially identical to the first cam 72 and includes a first portion 74A and a second portion 74B. The second cam 74 rotates about a second axis of rotation A₂.

As shown at the angle 76 in FIG. 4, the first portion 72A, 74A comprises about 190 degrees of the outer circumferential surface of the cam 72, 74, and the second portion 72B, 74B comprises about 170 degrees of the outer circumferential surface of the cam 72, 74. Alternatively, the angle 76 may be any desired angle within the range of from about 181 to about 200 degrees and the angle 82 may be any desired angle within the range of from about 160 to about 179 degrees, such that the angle 76 is always larger than the angle 82.

A radially extending cam surface 78 is defined between the outer circumferential surfaces of the first portion 72A and the second portion 72B, respectively, of the first cam 72. Similarly, a radially extending cam surface 79 is defined between the outer circumferential surfaces of the first portion 74A and the second portion 74B, respectively, of the second cam 74. As shown in FIG. 4, the first cam 72 rotates counterclockwise (in the direction of the arrow 80) and the second cam 74 rotates clockwise (in the direction of the arrow 82).

The first and second axes of rotation A₁ and A₂ of the first and second cams 72 and 74, respectively, may be spaced any desired distance apart. In the exemplary embodiment shown in FIG. 4B, the cams 72 and 74 may be spaced apart such that the outer circumferential surfaces of the portions 72A and 72B are vertically spaced apart a distance D₂ from the outer circumferential surfaces of the portions 74B and 74A, respectively. The outer circumferential surface of the portion 72B therefore overlaps the outer circumferential surface of the portion 74B by a distance D₁. In one embodiment, the distance D₁ is about 1.5 inches and the distance D₂ is about ½ inch. In the illustrated embodiment, the surfaces 78 and 79 are horizontally spaced apart a distance D₃. In one embodiment, the distance D₃ is about 2 inches. It will be understood that the distances D1, D1, and D3 may be determined by the dimensions of the shingle used in the particular application.

In the illustrated embodiment, the plates 84 of the first and second cams 72 and 74 are vertically aligned (transverse to the axes A₁ and A₂). Alternatively, the plates 84 of the first cam 72 and plates 84 of the second cam 74 may be offset in the axial direction.

Referring now to FIGS. 4, 6, and 7, a first embodiment of a diverter is generally shown at 86. The exemplary embodiment of the diverter 86 is formed from a plurality of substantially parallel and spaced apart diverter plates 88 fixedly mounted together. Three diverter plates 84 are illustrated, however any desired number of cam plates 84 may be provided. In the illustrated embodiment, the three diverter plates 88 are configured such that a portion of the plates 88 at the first end 87 of the diverter 86 are positioned in the spaces between the four cam plates 84.

The diverter plates 88 may be formed from any suitable material. Examples of suitable materials include steel, engineered plastics, and aluminum. Any suitable wear resistant material suitable for use in a roofing material manufacturing plant, such as steel with a high-wear resistant circumferential surface, can be used. The selection of material, and number and dimensions of the plates 88 may be determined by the dimensions of the dimensions of the shingle used in the particular application.

The illustrated diverter plates 88 are about ½ inch thick. It will be understood that the diverter plates 88 may be any desired thickness, such as within the range of from about ⅛ inch to about 3 inches thick. Alternatively, an upper surface of the diverter 86 may be formed having a continuous planar surface.

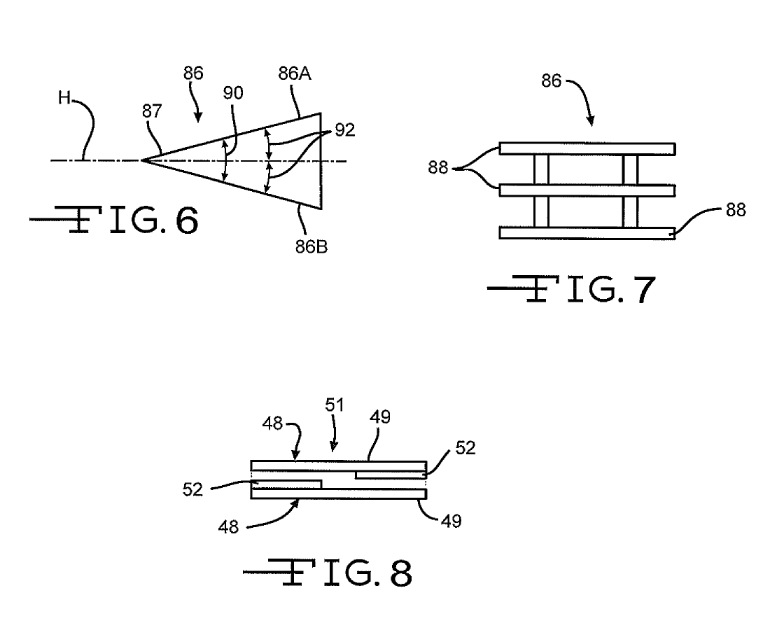

As best shown in FIG. 6, the diverter plates are substantially triangular in shape. In the illustrated embodiment, the first end 87 has an angle 90 of about 30 degrees. More specifically, the upper surface 86A is positioned at an angle 92 of about 15 degrees from horizontal (indicated by the line H), and the lower surface 86B is positioned at the angle 92 of about 15 degrees from horizontal. The upper and lower surfaces 86A and 86B of the diverter 86 may be formed at any suitable angle relative to horizontal.

A diverter guide member 94, the purpose for which will be explained in detail below, is disposed below and spaced apart from the diverter 86.

The exemplary embodiment of the diverter guide member 94 is formed from as a substantially planar member. If desired, the diverter guide member 94 may be formed from a plurality of substantially parallel and spaced apart diverter plates (not shown) fixedly mounted together in a manner similar to the diverter plates 88. It will be understood that the diverter guide member 94 may not be required. For example, if the shingles 48 travel fast enough between the cams 72 and 74 and the downstream shingle processing apparatus, the diverter guide member 94 may be omitted.

The diverter guide member 94 may be formed from any suitable material. Examples of suitable materials include steel, engineered plastics, and aluminum. Any suitable wear resistant material known to be suitable for use in a roofing material manufacturing plant, such as steel with a high-wear resistant circumferential surface and/or planar surface can be used. Any other suitable metal and non-metal may also be used. The selection of material, structure, and dimensions of the diverter guide member 94 may be determined by the dimensions of the shingle used in the particular application.

Referring again to FIGS. 3 and 4, a first embodiment of an apparatus for twisting and stacking shingles is generally shown at 68. The exemplary embodiment of the apparatus 68 includes a first conveyor 96 and a second conveyor 97. The second conveyor is structured and configured to invert the shingles, and can be in the form of a twister assembly 108. The second conveyor 97 can also be structured in other forms, different from the twister assembly.

The first conveyor 96 includes a continuous conveyor belt 98 extending between a conveyor head pulley 100 and a conveyor tail pulley 102. An intermediate pulley 104 is disposed intermediate the pulleys 100 and 102.

The exemplary embodiment of the twister assembly 108 includes a first twister conveyor 110 and a second twister conveyor 118. The first twister conveyor 110 includes a continuous conveyor belt 112 extending between a conveyor head pulley 114 and a conveyor tail pulley 116. The second twister conveyor 118 includes a continuous conveyor belt 120 extending between a conveyor head pulley 122 and a conveyor tail pulley 124. An optional intermediate pulley 126 is disposed intermediate the pulleys 122 and 124

If desired, a speed-up roller 130 may be provided adjacent the tail pulley 124 to increase the speed of the shingle pairs 51 relative to the speed of the first and second conveyors. The speed-up roller 130 moves the shingle pairs 51 to a catcher, schematically illustrated at 132 in FIG. 3. The shingle pairs 51 may then be moved by any conventional method to a stacker, schematically illustrated at 134 in FIG. 3. The catcher 132 and the stacker 134 may be of any desired design, such as disclosed in U.S. Pat. Nos. 4,124,128 and 4,384,813, both of which are incorporated herein by reference.

Referring again to FIG. 3, the lower portion of the continuous belt 112 and the upper portion of the continuous belt 120 are positioned immediately adjacent one another and twist 180 degrees between the head pulleys 114 and 122 and the tail pulley 116 and the intermediate pulley 126, respectively.

Additional conveyor belts (not shown) or other structure (not shown), including but not limited to portions of the apparatus 68, may be provided adjacent the longitudinal edges of the continuous belts 112 and 120 to prevent the shingle from moving laterally outwardly from between the adjacent belts 112 and 120 while the belts 112 and 120 move in the direction of the arrow 128 and twist 180 degrees, as described above. Such other structure includes, but is not limited to, pairs of pin rolls (not shown) positioned on opposite sides of the twisted belt pair 112 and 120. The location of such pin rolls may include, but is not limited to a mid-point of the twister assembly 108.

The illustrated process of twisting and stacking involves moving individual shingles 48 in a machine direction (indicated by the arrows 106 and 128) through a diverter assembly 70, and the first conveyor 96 and the twister assembly 108.

In a first step of the twisting and stacking process, manufactured shingles 48, with the granule covered surface 49 facing upwardly, are engaged by a roller 64 and moved between the cams 72 and 74 of the diverter assembly 70. As shown in FIG. 4, the cams 72 and 74 are in a first position. As a first of a series of shingles 48, positioned head to tail, is urged between the cams 72 and 74, the cams 72 and 74 continue to rotate, urging and guiding the first shingle 48 onto the upper surface 86A of the diverter 86 and onto the first conveyor 96. The shingle 48, with the granule covered surface 49 facing upwardly, then travels in the direction of the arrow 106.

The phase of the rotating cams 72 and 74 is controlled such that the cam surfaces 78 and 79 pass the point P) coincident with the passing of the end cuts E of any two sequential shingles 48, as best shown in FIG. 4C. When for example, the distance D₃=2 inches, there is a +/−1 inch tolerance zone in which the shingle end cuts must be positioned as they travel between the cams 72 and 74.

In a second step of the twisting and stacking process, a second of the series of spaced apart shingles 48, with the granule covered surface 49 facing upwardly, is engaged by a roller 64 and moved between the cams 72 and 74 of the diverter assembly 70. As shown in FIG. 4A, the cams 72 and 74 have rotated 180 degrees to a second position. The second of the series of spaced apart shingles 48 is urged between the cams 72 and 74. The cams 72 and 74 continue to rotate, urging and guiding the second shingle 48 between the lower surface 86B of the diverter 86 and the diverter guide member and between the head pulleys 114 and 122. The head pulleys 114 and 122 urge the shingle 48 between the lower portion of the continuous belt 112 and the upper portion of the continuous belt 120, such that the shingle is retained therebetween and moves with the belts 112 and 120.

As the shingle 48 moves with the belts 112 and 120 the shingle 48 is rotated 180 degrees as the belts 112 and 120 also twist 180 degrees between the head pulleys 114 and 122 and the tail pulley 116 and the intermediate pulley 126, respectively. The shingle 48 then emerges from the twister assembly 108, between the pulleys 116 and 126, such that the shingle 48 is disposed on the upper portion of the continuous belt 120 with the granule covered surface 49 facing downwardly. The first shingle 48 traveling on the first or upper conveyor 96 is then dropped onto the second shingle 48 traveling on the belt 120 at the region identified by the numeral 140, thereby defining a shingle pair 51. As shown in FIG. 8, the granule covered surfaces 49 of the shingles 48 in the shingle pair 51 are oriented outwardly. This shingle pair arrangement 51 advantageously places the underlay sheets 52 of each shingle 48 in the pair 51 substantially in the same plane, reducing humping and/or bulging when stacked.

In the illustrated embodiment of the apparatus for twisting and stacking shingle 68, the conveyors 96, 110, and 120 all travel at the same speed. To ensure that each shingle 48 of the pair of first and second shingles 48 simultaneously arrive at the region 140, the first conveyor 96 is about one shingle length longer than the first twister conveyer 110, as shown in FIG. 3. Accordingly, the first shingle 48 traveling on the upper conveyor 96 arrives as the region 140 substantially simultaneous with the second shingle 48 traveling on the belt 120. Any adjustments to the position of the first shingle relative to the second single in a stacked pair may be made at the catcher 130. Such adjustment may be provided by, but not limited to, a stop feature (not shown) in the catcher 130, which functions to align the first and second shingles in the shingle pair.

As explained above, the conveyors 96, 110, and 118 all travel at the same speed. In the embodiment described above, these conveyors travel at the same speed as the line speed of the shingles 48 that are being fed by the feed rollers 64 in an end-to-end condition into the diverter assembly 70. There is no need for the conveyors 96, 110, and 118 to be speeded up to operate at a speed greater than the line speed of the input stream of end-to-end shingles being fed through the feed rollers 64 because the diverter assembly is capable of separating every other shingle at the same speed as the line speed of the supply stream. It is to be understood that conveyors 96, 110, and 118 could be configured to operate at a faster speed than that of the input stream if needed for another purpose.

The shingle 48 has been described as a two-layered laminated shingle. It will be understood however, that the method and apparatus for stacking shingles described herein may be successfully practiced with any desired shingle, including, but not limited to a single layer shingle or a laminated shingle having more than two layers.

In one embodiment, a mechanism, not shown, can be used to pinch or squeeze the twister conveyors 110, and 118 together in the vicinity of the midway point between the two ends of those conveyors, i.e., midway between the conveyor head pulleys 114 and 122 and the conveyor tail pulleys 116 and 124. The purpose of the mechanism is to prevent the shingles carried by the twister conveyors 110 and 118 from falling out or slipping when the shingles and conveyors are oriented vertically. Such a mechanism can take a number of forms. In one embodiment the mechanism includes the use of a rim or lip on the edge of the twister conveyors 110 and 118 to prevent vertical slippage of the shingles. In another embodiment, one or more pairs of rollers, not shown, are used to pinch the twister conveyors 110 and 118 together at the point of vertical orientation. Such rollers can be an opposed pair of rollers arranged to be spaced apart from each other with a gap slightly less than the thickness of the thickest portion of the expected shingle and the thickness of the two conveyors twister 110 and 118. In one embodiment the rollers are 4 inch diameter wheels with a wheel surface having a width of about 1 inch. Any number of pairs of rollers can be used, with the pairs being spaced apart from each other along the middle portion of the twister conveyors 110 and 118. For example, three pairs of rollers could be employed.

Although a pair of twister conveyors 110 and 118 is shown for inverting the shingles, it is to be understood that in other embodiments a single conveyor could be configured to convey the shingles while inverting them.

The principle and mode of operation of the method of stacking shingles have been described in its preferred embodiment. However, it should be noted that the method of stacking shingles described herein may be practiced otherwise than as specifically illustrated and described without departing from its scope.

What is claimed is:

1. A method of stacking shingles comprising:
manufacturing a plurality of shingles having a granule covered surface and a bottom surface opposite the granule covered surface;
separating every other shingle into first and second paths;
inverting 180 degrees the shingles in the second path; and
positioning a shingle from the first path onto a shingle from the second path, such that the bottom surfaces of each shingle are engaged, thereby defining a stacked pair of shingles.

2. The method according to claim 1, wherein the plurality of shingles is a plurality of laminated shingles having an overlay sheet laminated to an underlay sheet.

3. The method according to claim 1, further including stacking a plurality of stacked pairs of shingles.

4. The method according to claim 1, further including merging the first and second paths of shingle subsequent to inverting 180 degrees the shingles in the second path.

5. The method according to claim 1, wherein the shingle from the first path and the shingle from the second path are received and stacked on a shingle receiving portion of a shingle stacking apparatus.

6. The method according to claim 5, further including moving the first shingle of a pair of shingles in the first path such that the first shingle and the second shingle of the pair arrive at the shingle receiving portion substantially simultaneously.

7. The method according to claim 5, wherein the first path is longer than the second path.

8. The method according to claim 7, wherein the first path is substantially one shingle length longer than the second path.

9. The method according to claim 5, further including moving the stacked pair of shingles to shingle catcher, wherein the stacked pair of shingles are collected for subsequent processing.

10. A shingle stacking apparatus comprising:
a first assembly structured and configured to move a stream of shingles;
a diverter assembly structured and configured to engage and separate every other shingle in the stream of shingles into a first stream on a first conveyor and a second stream on a second conveyor;
wherein the second conveyor is structured and configured to invert 180 degrees from a first end to a second end thereof, the shingles on the second conveyor being inverted 180 degrees; and
a shingle receiving portion upon which an inverted shingle from the second conveyor is first deposited, and a shingle from the first conveyor is then deposited on the inverted shingle, such that the bottom surfaces of the shingles from each of the first and second conveyors are engaged, thereby defining a stacked pair of shingles.

11. The shingle stacking apparatus according to claim 10, wherein the diverter assembly includes a first and second cam, each cam comprising a substantially cylindrical member having a first portion defining an outer circumferential surface having a first radius, and a second portion defining an outer circumferential surface having a second radius, wherein the first radius is smaller than the second radius, and wherein a radially extending cam surface is defined between the outer circumferential surface of the first portion and the outer circumferential surface of the second portion.

12. The shingle stacking apparatus according to claim 11, wherein the first cam rotates about a first axis in a first direction and the second cam rotates about a second axis in a second direction opposite the first direction, wherein the first and second axes are spaced a distance apart, and wherein the first and second cams are structured and configured to rotate such that the cam surface of the first cam and the cam surface of the second cam move in phase with the end surfaces of shingles passing between the first and second cams.

13. The shingle stacking apparatus according to claim 12, wherein when the first and second cams are structured and configured to rotate in phase with the end surfaces of shingles passing therebetween, a space is defined between the cam surface of the first cam and the cam surface of the second cam, and wherein the diverter assembly is structured and configured to position the end surfaces of shingles passing between the first and second cams within the space.

14. The shingle stacking apparatus according to claim 10, wherein the first and second conveyors intersect such that a shingle carried on the first conveyor is deposited onto a shingle carried on the second conveyor.

15. The shingle stacking apparatus according to claim 10, wherein the second conveyor is a twister assembly comprising a first twister conveyor and a second twister conveyor.

16. The shingle stacking apparatus according to claim 15, wherein a portion of a continuous belt of the first twister conveyor is structured and configured to engage and move simultaneously with a portion of a continuous belt of the second twister conveyor, the engaged portion of the first and second twister conveyors defining a shingle-carrying space therebetween; and wherein the shingle-carrying space, and a shingle from the second stream of shingles carried therein, move from a first end to a second end of the twister assembly.

17. The shingle stacking apparatus according to claim 10, wherein the first conveyor is substantially one shingle length longer than the second conveyor.

18. The shingle stacking apparatus according to claim 10, further including a shingle stacker structured and configured to stack the stacked pairs of shingles for subsequent packaging.

19. A method of stacking shingles comprising:
introducing a stream of shingles into a diverter assembly, the diverter assembly defining a first shingle path and a second shingle path, the first shingle path positioned at a first distance relative to a mid-point of the diverter assembly, the second path spaced apart from the first path and positioned at a second distance relative to the mid-point of the diverter assembly;
urging a first shingle from the stream of shingles into the first shingle path; and
urging a second shingle from the stream of shingles into the second shingle path, thereby separating every other shingle from the stream of shingles into first and second spaced apart shingle paths.

20. The method according to claim 19, further including:
inverting 180 degrees the shingles in the second shingle path; and
positioning a shingle from the first shingle path onto a shingle from the second shingle path, such that bottom surfaces of each shingle are engaged, thereby defining a stacked pair of shingles.

21. A method of handling shingles comprising:
manufacturing a continuous strip of granule coated shingle material at a line speed greater than 400 feet per minute, the continuous strip material having a granule covered surface and a bottom surface opposite the granule covered surface;
cutting the continuous strip into a plurality of shingles traveling head-to-toe at the line speed; and
separating every other shingle into first and second paths.

22. The method of claim 21 in which the head-to-toe shingles are separated by diverter assembly that includes opposed rotatably mounted first and second cams, the cams having outer circumferential surfaces of differing radii, the cams being arranged so that the first cam and second cam separate every other shingle, respectively.

23. The method of claim 22 in which each cam comprises a substantially cylindrical member having a first portion defining an outer circumferential surface having a first radius, and a second portion defining an outer circumferential surface having a second radius, wherein on each cam the first radius is smaller than the second radius, and wherein a radially extending cam surface is defined between the outer circumferential surface of the first portion and the outer circumferential surface of the second portion.

24. The method of claim 23 in which the cams are synchronized so that one shingle of the head-to-toe shingles is presented with the first radius of first cam and the second radius of the second cam at the point of separation of the head-to-toe shingles, and the next shingle of the head-to-toe shingles is presented with the first radius of second cam and the second radius of the first at the point of separation of the head-to-toe shingles.

25. The method of claim 21 in which the separated shingles are subsequently reunited and stacked together back-to-back, and collected at the line speed in a single shingle stacker.

26. The method of claim 21 in which the separated shingles are laminated shingles.
